(19) United States
(12) Patent Application Publication
(10) Pub. No.: US 2008/0129734 A1
(43) Pub. Date: Jun. 5, 2008

(54) APPARATUS AND METHOD OF RAY-TRIANGLE COLLISION DETECTION FOR RAY-TRACING

(75) Inventors: Nam Seung-Woo, Daejeon (KR); Kim Sung-Soo, Daejeon (KR); Jang Ho Wook, Daejeon (KR); Kim Haedong, Daejeon (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Electronics and Telecommunications Research Institute, Daejeon (KR)

(21) Appl. No.: 11/947,449

(22) Filed: Nov. 29, 2007

(30) Foreign Application Priority Data
Dec. 5, 2006 (KR) 10-2006-0122344
Sep. 28, 2007 (KR) 10-2007-0098055

(51) Int. Cl. G06T 11/20

(52) U.S. Cl. 345/440

(57) ABSTRACT

Provided are an apparatus and method for detecting ray-triangle collision for ray-tracing. The apparatus includes a ray bundle memory for storing ray bundle, a geometry data memory for storing geometry triangle data, a hierarchy structure memory for storing space subdivision and bounding volume hierarchy structure information, a virtual pager for receiving the geometry triangle data, the space subdivision and bounding volume hierarchy structure information, and the bounding hierarchical structure information by rearranging geometry triangle data by final end nodes, a virtual paged memory for receiving the rearranged data, forming page memories, and storing triangle data by pages, a virtual page cache for processing the page data in a pipe line manner, and previously storing a page memory for collision detection, a ray-triangle collision detection pipe for detecting a ray-triangle collision based on the page memory and the ray bundle, and an output memory for storing the ray-triangle collision detection result.

### BACKGROUND OF THE INVENTION

1. Field of the Invention

The present invention relates to an apparatus and method for ray-triangle collision detection for ray-tracing, and more particularly, to an apparatus and method for quickly calculating a collision between ray and geometric data in ray-tracing and for calculating a collision point, whether a collision is detected or not, and texture coordinates in a three-dimensional space.

This work was supported by the Information Technology (IT) research and development program of the Korean Ministry of Information and Communication (MIC) and/or the Korean Institute for Information Technology Advancement (IITA) [2006-S-045-01, “Development of Function Extensible Real-Time Renderer”].

2. Description of the Related Art

Rendering is a process of drawing a three-dimensional object in a two-dimensional image by covering the three-dimensional object with more than four information such as a shape, a location, a light source, and a view point in order to give solidity effect thereon.

Such a rendering process generally took long time to draw each of two-dimensional images due to a rendering algorithm that draws each of two-dimensional images by finely drawing a detail image on a three-dimensional object. In general, a 3D animation was produced by drawing each of two-dimensional images through the rendering process, and gathering and editing 24 two-dimensional images in a unit of a second.

The development of a graphic processor and the improvement of the rendering algorithm enable a general desk top computer to display such 3-D animation through real-time rendering. That is, a general desk top can draw more than 24 two-dimensional images of a 3-D object in a second through real time rendering.

Although various real-time rendering schemes were introduced, a simple rendering scheme was commonly used rather than a high quality rendering scheme.

As the simple rendering algorithm, a line removing algorithm such as a Z buffer algorithm and a scan line algorithm, and an expression mapping scheme such as a texture-bump-environment mapping, and a physically based local illumination modeling were introduced.

Generally, a graphic processor processes the 3D graphics of lately introduced 3D games based on the above described real time rendering algorithms with software such as API of Direct X or OpenGL according to corresponding hardware configuration. On the contrary, in case of drawing a representative animation or a picture in real time with 3D graphic software, a high quality rendering scheme is used because the real time rendering is not required. One of the representative high quality rendering schemes is a global illumination modeling scheme. The global illumination modeling scheme includes ray-tracing, radiosity, and photon map ray tracing.

In case of a dual ray tracing rending scheme, geometry data is formed in a hierarchical structure, bounding volume hierarchy, or space subdivision structure in order to increase a speed of collision detection.

However, ray-tracing rendering based hardware for detecting a ray-geometry data collision has following problems.

At first, the operating rate of a memory deteriorates because the reusability of a triangle memory was not considered.

Secondly, a related memory process cannot be processed before ray-triangle collision detection because a memory structure formed based on a hierarchical structure and a geometry structure by space subdivision is used. Therefore, the ray-tracing rendering based hardware took a long time for rendering.

In order to overcome such problems, a system architecture for high speed ray tracing was introduced in U.S. Pat. No. 7,012,604 by Advanced Micro Devices, Inc. In the system architecture for high speed ray tracing, calculations for rays and pixel color values are processed using a plurality of tracing processors and shading processors in parallel in order to increase a calculating speed at a block generating a ray. However, the system architecture did not really increases the calculating speed because the system architecture identically processes data generated from a block generating a ray compared to another system architecture according to the related art. Therefore, it is still required to increase a speed of processing data generated from the block that generates a ray.

### SUMMARY OF THE INVENTION

Accordingly, the present invention is directed to an apparatus and method for detecting ray-triangle collision for ray-tracing which substantially obviates one or more problems due to limitations and disadvantages of the related art.

It is an object of the present invention to provide an apparatus and method for detecting ray-triangle collision for ray-tracing in order to effectively form a memory structure and a cache structure when an algorithm increasing a speed of ray-triangle collision detection using various hierarchical structures is embodied as hardware.

It is another object of the present invention to provide an apparatus and method for detecting ray-triangle collision for ray-tracing in order to reuse data without reading the related data from a memory again although the data varies in a dynamic environment by including a transformer in a hierarchical structure in consideration of the memory reusability.

It is still another object of the present invention to provide an apparatus and method for detecting ray-triangle collision for ray-tracing in order to make data input efficiently by rearranging geometry triangle data by final end nodes and detecting a collision of the rearranged data.

It is further still another object of the present invention to provide an apparatus and method for detecting ray-triangle collision in order to increase a transmission speed by disposing a ray-triangle collision detection pipe with a virtual pager, a virtual paged memory, a virtual paged cache, and an output memory in parallel for processing collision of triangle data.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided an apparatus for ray-triangle collision detection for ray-tracing including: a ray bundle memory for storing ray bundle as previously generated data; a geometry data memory for storing geometry triangle data having information about vertexes that form a triangle for geometry data; a hierarchy structure memory for storing space subdivision and bounding volume hierarchy structure information and bounding hierarchy structure information; a virtual pager for receiving the geometry triangle data, the space subdivision and bounding volume hierarchy structure information, and the bounding hierarchical structure information from the hierarchy structure memory and the geometry data memory, and generating triangle data by rearranging geometry triangle data by final end nodes; a virtual paged memory for receiving the rearranged data by triangles, forming page memories corresponding to the triangles in a page memory format, and storing triangle data outputted from the virtual pager by pages; a virtual page cache for processing the page data in a pipe line manner, and previously storing a page memory for collision detection among page memories of the virtual paged memory; a ray-triangle collision detection pipe for detecting a ray-triangle collision based on the page memory stored in the virtual paged cache and the ray bundle of the ray bundle memory as input; and an output memory for storing an output for a triangle collided with each ray, which is processed by the ray-triangle collision detection pipe.

In accordance with another purpose of the invention, there is provided a method for detecting ray-triangle collision for ray-tracing, including the steps of: a) generating a ray, making the generated ray to traverse along a geometry hierarchy structure, classifying obtained scene data to ray bundle, hierarchy structure, and geometry triangle data, and storing the ray bundle, the hierarchy structure, and the geometry triangle data into a ray bundle memory, a hierarchy structure memory, and a geometry data memory, respectively; b) detecting collisions among the stored ray bundle, hierarchical structure of geometry data, and geometry triangle data; and c) outputting a result of the collision detection and storing the collision detection result in an output memory.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 is a block diagram illustrating an apparatus for detecting ray-triangle collision according to an embodiment of the present invention;

FIG. 2 is a block diagram illustrating a configuration for a pipe line process in the apparatus for detecting ray-triangle collision shown in FIG. 1 according to an embodiment of the present invention;

FIG. 3 is a flowchart illustrating a ray tracing procedure including collision detection according to an embodiment of the present invention.

FIG. 4 is a diagram illustrating a data structure in a hierarchy structure memory and a geometry data memory according to an embodiment of the present invention.

FIG. 5A and FIG. 5B are diagrams for describing the forming of a virtual paged memory at a virtual pager from a hierarchy structure memory and a geometry data memory.

FIG. 6 is a diagram illustrating data structures of a virtual page memory and a physical memory based on the relation of a page memory and a physical memory according to an embodiment of the present invention.

### DETAILED DESCRIPTION OF THE INVENTION

Reference will now be made in detail to the preferred embodiments of the present invention, examples of which are illustrated in the accompanying drawings.

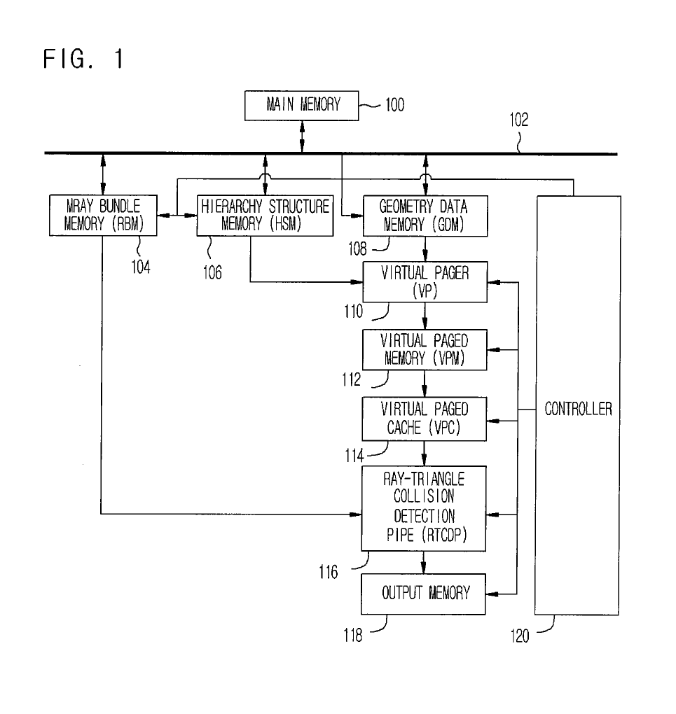

FIG. 1 is a block diagram illustrating an apparatus for detecting ray-triangle collision according to an embodiment of the present invention.

Referring to FIG. 1, the apparatus for detecting ray-triangle collision for ray-tracing according to the present embodiment includes a main memory 100, a ray bundle memory RBM 104, a geometry data memory GDM 108, a hierarchy structure memory HSM 106, a virtual pager VP 110, a virtual paged memory VPM 112, a virtual paged cache VPC 114, a ray-triangle collision detection pipe RTCDP 116, an output memory 118, and a controller 120.

The main memory 100 is connected to the ray bundle memory 104, the geometry data memory 108, and the hierarchy structure memory 106 through a bus interface 102. The main memory 100 stores the scene data of an image processed by an input device (not shown) and a digital signal processor (DSP) in advance or in real time in order to process the scene data to a ray-triangle collision processed image data and ray bundle.

The bus interface 102 connects the main memory 100 to one of the ray bundle memory 104, the geometry data memory 108, and the hierarchy structure memory 106, which are controlled by the direct memory access and the controller 120 in order to transmit and receive data.

The previously generated data are geometry data and ray bundle, which are formed of triangle meshes. The geometry data and the ray bundle are used as the input of the virtual pager 110 and the ray-triangle collision detection pipe 116.

If ray is read one by one in ray-tracing, the hardware efficiency of a controlling device and the interface bus 102 deteriorates. Therefore, the ray bundle memory 104 reads more than one of rays in a bundle from the main memory 100 in response to the control of the DMA.

The geometry data memory 108 stores geometry triangle data having information about vertexes forming a triangle for scene data that is simplified to data of triangle. Therefore, the data stored in the geometry data memory 108 is referred as geometry triangle data. The virtual pager 110 rearranges and forms triangle data. The triangle data rearranged by the virtual pager 110 forms a virtual page memory based on the hierarchical structure of a geometry stored in the hierarchy structure memory and vertexes of triangle meshes stored in the geometry data memory.

The hierarchy structure memory 106 stores information about space subdivision related to the ray bundle and the geometry triangle data, bounding volume hierarchical structure information, and bounding hierarchical structure information.

The virtual pager 110 receives the hierarchical structure and space subdivision information from the hierarchy structure memory 106 and the geometry triangle data from the geometry data memory 108 and rearranges geometry triangle data by end nodes. That is, the virtual pager 110 rearranges the geometry triangle data of the geometry data memory 108 by triangles in an end node with the hierarchical structure of the hierarchy structure memory 106 as input. The data rearranged by the virtual pager is referred as triangle data. The virtual pager transfers the triangle data to the virtual paged memory 112.

The rearrangement of the virtual pager 110 will be described in more detail. The triangle data rearranged by the virtual pager 110 forms a virtual page memory based on the hierarchical structure of a geometry stored in the hierarchy structure memory and vertexes of triangle meshes stored in the geometry data memory. The triangle of the triangle data is formed of three vertexes, and the virtual page memory is stored in a page corresponding to a virtual page memory of triangles included in one end node.

In case of a physical memory 113 described later, the virtual page memory may be stored in one or more than one pages according to the number of triangles in an end node. Also, the virtual page memory may be sequentially stored in the sector of the physical memory 113.

The virtual paged memory 112 receives the rearranged triangle data and forms page data corresponding to each of the triangle based on a page memory format. The virtual paged memory 112 stores the rearranged page data from the virtual pager 110 by pages.

The virtual paged cache 114 is included for processing data in a pipe line manner at the ray-triangle collision detection pipe 116. The virtual paged cache 114 previously store page data for collision detection among page data that denotes an end node in the virtual paged memory 112.

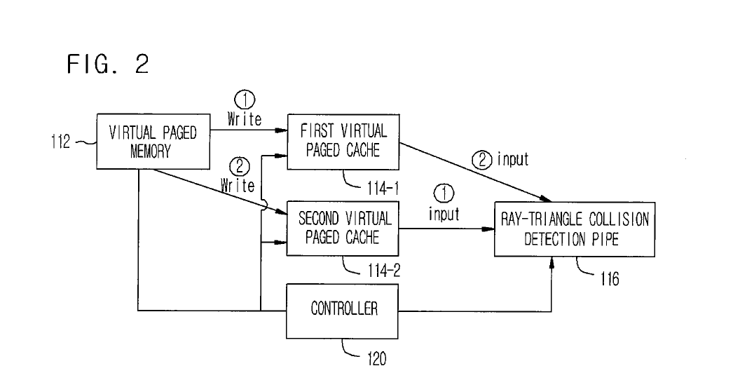

FIG. 2 is a block diagram illustrating a configuration for a pipe line process in the apparatus for detecting ray-triangle collision shown in FIG. 1 according to an embodiment of the present invention.

Referring to FIG. 2, in the pipe line process, the data of the first virtual paged cache 114-1 inputs to the ray triangle collision detection pipe 116 while the virtual paged memory 112 writes page data on a second virtual paged cache 114-2. If the entire data of the first virtual paged cache 114-1 is used, the virtual paged memory 112 writes page data to the first virtual paged cache 114-1 while the data of the second virtual paged cache 114-2 inputs to the ray-triangle collision detection pipe 116.

The ray-triangle collision detection pipe 116 receives the ray bundle from the ray bundle memory 104 and rearranges the received ray bundle. The ray-triangle collision detection pipe 116 receives geometry triangle data from parallel connected virtual page memory 112 through the virtual paged cache 114. The ray-triangle collision detection pipe 116 inspects the collision between the rearranged ray bundle and the geometry triangle data.

Referring to FIG. 1 again, the ray-triangle collision detection pipe 116 is connected to the virtual pager 110, the virtual paged memory 112, the virtual paged cache 115, the output memory 118, and the controller 120 in parallel, and the ray-triangle collision detection pipe 116 receives the triangle data of an end node from the virtual paged memory 112 in response to the controller 120.

The output of the ray-triangle collision detection pipe 116 is a result of the collision of the ray bundle and the geometry triangle data. That is, the ray-triangle collision detection pipe 116 calculates a collision point, a texture coordinate (u, v), and a distance t to the collided triangle for a vector v formed of a start point o and a direction d of a ray.

Also, the ray-triangle collision detection pipe 116 includes a transformer not to read triangle data from the virtual paged memory 112 again.

The output memory 118 stores the shortest collision distance t for collided triangle for each ray, and the texture coordinate (u, v) and collision point thereof, which are processed from the ray-triangle collision detection pipe 116 and outputs the stored collision distance t, texture coordinate (u, v), and collision point through an output device if it necessary.

Meanwhile, after the shown ray-triangle collision detection pipe 116 is connected to the virtual pager 110, the virtual paged memory 112, the virtual paged cache 114, the output memory 118, and the controller 120 in parallel, another ray-triangle collision detection pipe 116 may be connected in parallel. In this case, two ray-triangle collision detection pipes 116 and two virtual paged caches 114-1 and 114-2 may be disposed in 1:1 manner in order to enable the two ray-triangle collision detection pipes 116 to share the virtual paged caches 114-1 and 114-2 in parallel. In this case, the recorded data is identical. That is, since the inputs of two ray triangle collision detection pipes 116 are the same, the battle-neck problem is not occurred for reading data from the virtual paged memory 112 to the virtual paged caches 114-1 and 114-2 when the data is processed in parallel. However, rays inputted to the ray bundle memory 104 are different for each of pipe lines.

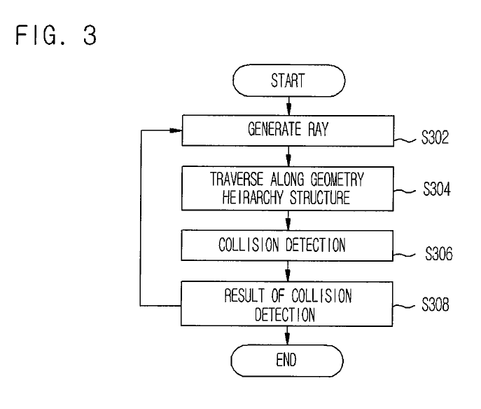

FIG. 3 is a flowchart illustrating a ray tracing procedure including collision detection according to an embodiment of the present invention.

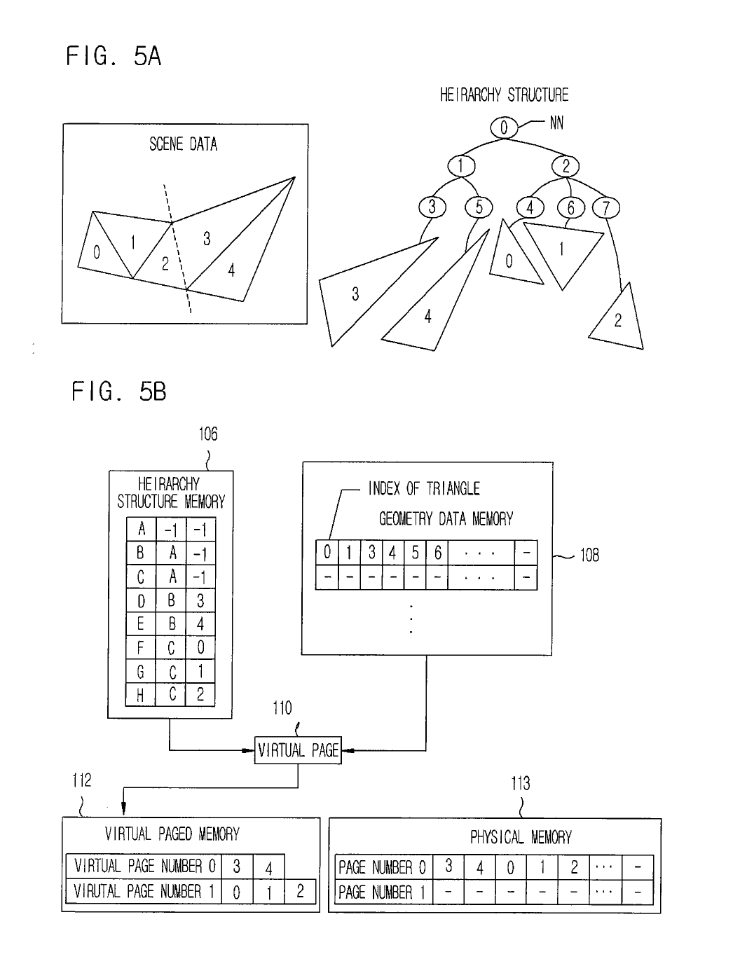

Referring to FIG. 3, at first, a ray is generated at step S302. The generated ray can be formed in a hierarchical structure of geometry data as shown in FIGS. 5A and 5B, which will be described later.

Each scene data is classified into a ray bundle, a hierarchical structure of geometry data, and geometry triangle data, and the classified information is stored in the ray bundle memory 104, the hierarchy structure memory 106, and the geometry data memory 108 by making the generated ray to traverse along a geometry hierarchy structure at step S304.

The ray-triangle collision detection pipe 116 detects collision of the stored ray bundle, geometry data hierarchical structure, and geometry triangle data at step S306.

Then, the ray-triangle collision detection pipe 116 outputs the result of collision detection at step S308. The outputted result is stored in the output memory 118.

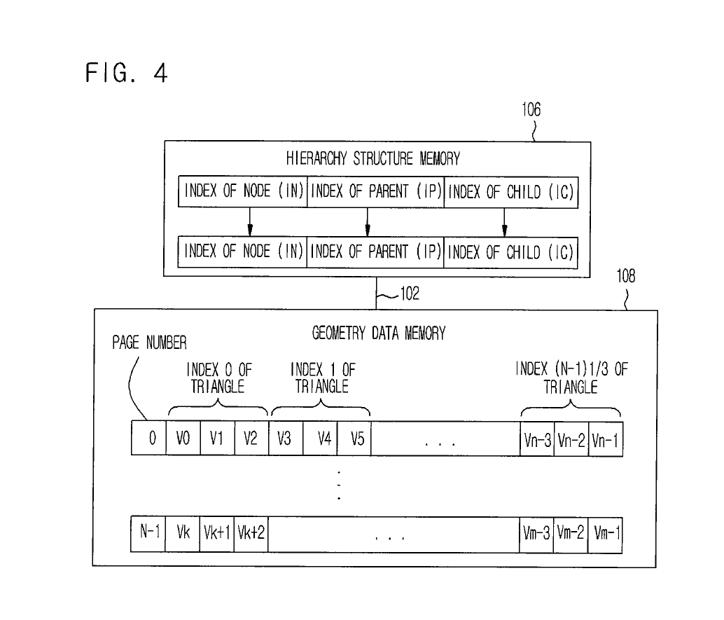

FIG. 4 is a diagram illustrating a data structure in a hierarchy structure memory and a geometry data memory according to an embodiment of the present invention.

Referring to FIG. 4, the hierarchy structure memory 106 and the geometry data memory 108 are connected to the main memory 100 and the controller 120 through the bus interface 102. The bus interface 102 accesses the main memory 100 and reads information from the main memory 100 in response to the control of DMA (not shown) and the controller 120.

The hierarchy structure memory 106 stores a plurality of hierarchical structure information in data sequence format. A data sequence forming a hierarchical structure includes an index of node (IN), an index of parent (IP), and an index of child (IC). The index of node is a code of node index information, and it is stored as serial numbers. The index of parent (IP) is a code of information about a location of an index of parent hierarchy, and the index of child (IC) is a code of information about a location of an index of child hierarchy.

The geometry data memory 108 is constituted of a plurality of data sequences that form a plurality of geometry triangle data. In one of the data sequences forming the geometry triangle data, a first block is allocated for a page number (PN), the next three blocks are allocated for the index 0 of a triangle, and the next three blocks are allocated for the index 1 of a triangle. Finally, the index (n−1)1/3 of a triangle is disposed, thereby forming one data sequence. One data sequence forms one scene data. An animation is constituted of a plurality of such data sequences.

FIG. 5A and FIG. 5B are diagrams illustrating a data structure for forming a virtual paged memory at a virtual pager from a hierarchy structure memory and a geometry data memory.

Referring to FIG. 5A and FIG. 5B, FIG. 5A shows an example of forming scene data in a hierarchical structure.

The scene data corresponds to a hierarchical structure, the hierarchical structure corresponds to a node number. Such a hierarchically structured scene data is stored in the hierarchy structure memory 106. The geometry triangle data is the scene data simplified to triangles, and each vertex of the geometry triangle data is stored in the geometry data memory 108. That is, the coordinate of each vertex is stored in the geometry data memory 108.

The hierarchical structure information stored in the hierarchy structure memory 106 includes space subdivision and bounding volume hierarchical structure information and bounding hierarchy structure information.

The virtual pager 110 receives the hierarchical structure and space subdivision information and the geometry triangle data from the hierarchy structure memory 106 and the geometry data memory 108 and rearranges the geometry triangle data by a final end node. That is, the virtual pager VP rearranges the triangle data of the geometry data memory GDM by triangles in an end node based on the hierarchy structure of the hierarchy structure memory (HSM). Then, the virtual pager VP transfers the rearranged triangle data to the virtual paged memory 112. The virtual paged memory 112 stores the rearranged triangle data as page data. The ray-triangle collision detection pipe 116 and the virtual paged cache 114 perform the pipe line process on the stored page data in response to the controller.

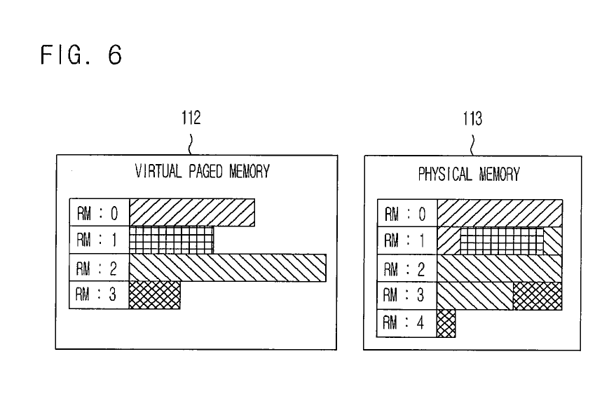

Although the virtual paged memory 112 stores the same information stored in the physical memory 113, the virtual paged memory 112 has different structure. It will be described in detail with reference to FIG. 6.

FIG. 6 is a diagram illustrating data structures of a virtual page memory and a physical memory based on the relation of a page memory and a physical memory according to an embodiment of the present invention.

Referring to FIG. 6, a page memory is sectored by each of triangles of a virtual page memory. Since the page memory includes the hierarchical structure information and page data of each triangle, the size of memory may be different. That is, a page memory corresponding to a triangle can store data with different capacity in one line. However, the page data in the physical memory 113 stores data with the same capacity in each sector because the capacity stored in each sector is limited in the physical memory 113.

As described above, the apparatus and method for detecting ray-triangle collision for ray-tracing according to the present invention can increase a speed of collision between a ray and a triangle mesh using a bounding volume hierarchical structure such as OBB-tree, KD-tree, Binary-tree, and AABB-tree.

In the apparatus and method for detecting ray-triangle collision for ray-tracing according to the present invention, a transformer is included in a hierarchy structure to reuse data without reading the data from a memory in a dynamic environment. Therefore, the apparatus and method for detecting ray-triangle collision for ray-tracing according to the present invention improve the reusability of a triangle memory.

Also, the apparatus and method for detecting ray-triangle collision for ray-tracing according to the present invention rearrange geometry triangle data by final end nodes and detect the collision of the rearranged data, thereby improving the efficiency of data input.

Furthermore, the apparatus and method for detecting ray-triangle collision for ray-tracing according to the present invention increase the transmission speed by configuring the ray-triangle collision detection pipe, the virtual pager, the virtual paged memory, the virtual paged cache, and the output memory in parallel for processing collision of triangle data.

What is claimed is:

1. An apparatus for ray-triangle collision detection for ray-tracing comprising:
a ray bundle memory for storing ray bundle as previously generated data;
a geometry data memory for storing geometry triangle data having information about vertexes that form a triangle for geometry data;
a hierarchy structure memory for storing space subdivision and bounding volume hierarchy structure information and bounding hierarchy structure information;
a virtual pager for receiving the geometry triangle data, the space subdivision and bounding volume hierarchy structure information, and the bounding hierarchical structure information from the hierarchy structure memory and the geometry data memory, and generating triangle data by rearranging geometry triangle data by final end nodes;
a virtual paged memory for receiving the rearranged data by triangles, forming page memories corresponding to the triangles in a page memory format, and storing triangle data outputted from the virtual pager by pages;
a virtual page cache for processing the page data in a pipe line manner, and previously storing a page memory for collision detection among page memories of the virtual paged memory;
a ray-triangle collision detection pipe for detecting a ray-triangle collision based on the page memory stored in the virtual paged cache and the ray bundle of the ray bundle memory as input; and
an output memory for storing an output for a triangle collided with each ray, which is processed by the ray-triangle collision detection pipe.

2. The apparatus of claim 1, wherein the triangle data forms the virtual page memory based on a geometry hierarchical structure stored in the hierarchy structure memory and vertexes forming a triangle of triangle data that forms a triangle mesh stored in the geometry data memory as input.

3. The apparatus of claim 2, wherein triangles included in one end node is stored at a corresponding page in the virtual page memory.

4. The apparatus of anyone of claims 1 to 3, further comprising a main memory connected to the ray bundle memory, the geometry data memory, and the hierarchy structure memory through a bus interface for storing images for processing images to ray-triangle collision processed image data.

5. The apparatus of claim 4, wherein the ray-triangle collision detection pipe includes a transformer to reuse triangle data read from the main memory.

6. The apparatus of claim 1, wherein the pipe line process divides the virtual paged cache into a first virtual page cache and a second virtual cache, inputs data stored in the first virtual paged cache to the ray-triangle collision detection pipe while the page memory of the virtual paged memory, and writes a page memory of the virtual page memory to the first virtual page caches while the data stored in the second virtual paged cache is used as the input of the ray-triangle collision detection pipe after entire data of the virtual paged cache is inputted.

7. The apparatus of claim 6, further comprising a controller for controlling the pipe line process.

8. The apparatus of claim 7, wherein the ray-triangle collision detection pipe is connected to the virtual pager, the virtual paged memory, the virtual paged cache, the output memory, and the controller in parallel, and is controlled by the controller.

9. The apparatus of claim 1, wherein a result outputted from the ray-triangle collision detection pipe and stored in the output memory includes a collision point of a ray bundle and geometry triangle data, a texture coordinate, and a distance to a collided triangle for a vector that is formed of a start point and a direction of a ray.

10. The apparatus of claim 6, further comprising a ray-triangle collision detection pipe connected to the ray-triangle collision detection pipe in parallel in order to mutually share the virtual paged cache in parallel.

11. A method for detecting ray-triangle collision for ray-tracing, comprising the steps of:
a) generating a ray, making the generated ray to traverse along a geometry hierarchy structure, classifying obtained scene data to ray bundle, hierarchy structure, and geometry triangle data, and storing the ray bundle, the hierarchy structure, and the geometry triangle data into a ray bundle memory, a hierarchy structure memory, and a geometry data memory, respectively;
b) detecting collisions among the stored ray bundle, hierarchical structure of geometry data, and geometry triangle data; and
c) outputting a result of the collision detection and storing the collision detection result in an output memory.

12. The method of claim 11, wherein the hierarchical structure information is formed in a form of a data sequence, and the data sequence is constituted of an index of a node, an index of parent, and an index of child.

13. The method of claim 11, wherein the geometry triangle data is constituted of a plurality of data sequences, and a page number is allocated into a first block, and indexes of each triangle are sequentially disposed in next blocks in the data sequence, where one index of a triangle is disposed in three blocks.

14. The method of claim 13, wherein the scene data corresponds to a hierarchical structure, the hierarchical structure corresponds to a node number, and the hierarchical structure information includes space subdivision and bounding volume hierarchical structure information and bounding hierarchical structure information.
